(19) United States
(12) Patent Application Publication
(10) Pub. No.: US 2016/0149959 A1
(43) Pub. Date: May 26, 2016

(54) Controlling a PBX Phone Call Via a Client Application

(71) Applicant: Microsoft Technology Licensing, LLC, Redmond, WA (US)

(72) Inventors: Shivaram Prabhakar, Redmond, WA (US); Darshan Vinodbhai Rajani, Bellevue, WA (US); Marcelo Pessanha Farjalla, Seattle, WA (US); Xing Du, Sammamish, WA (US); Sharmila Vijayan, Redmond, WA (US); David J. Moy, Sammamish, WA (US); Jia-Hao Fan, Redmond, WA (US); Aarthi Natarajan, Kirkland, WA (US)

(21) Appl. No.: 14/555,008

(22) Filed: Nov. 26, 2014

(51) Int. Cl. H04L 29/06; H04L 29/08; G06F 3/0481; G06F 3/0484; H04M 7/00; H04M 3/42

(52) U.S. Cl. CPC H04L 65/1046; H04M 7/0021; H04M 3/42323; H04M 7/0045; H04L 65/1006; H04L 65/1083; G06F 3/0481; G06F 3/04842; H04L 67/141

(57) ABSTRACT

In one or more embodiments, a hit test thread which is separate from the main thread, e.g. the user interface thread, is utilized for hit testing on web content. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in the response time that is consistently quick even on low-end hardware over a variety of scenarios.

### BACKGROUND

Voice-over-Internet Protocol (VoIP) provides a user with an affordable calling solution when compared to a traditional landline system. Some businesses take advantage of this to provide an affordable internal telephone network system, such as through a Private Branch Exchange (PBX). One advantage to the PBX system is that it can be configured to allow a desktop computer to run software that helps manage an associated PBX telephone and its options. However, making the desktop software function properly with a remote telephone typically involves multiple vendors and components. For example, to remotely control the PBX telephone, the desktop application relies upon an additional third-party component between the desktop application and PBX telephone, such as a Computer-Supported Telecommunications Application (CSTA) gateway. This addition of the third-party component oftentimes adds extra expense to the system, and additionally couples the desktop application to a vendor that is different from its own.

### SUMMARY

This Summary is provided to introduce a selection of concepts in a simplified form that are further described below in the Detailed Description. This Summary is not intended to identify key features or essential features of the claimed subject matter.

Various embodiments provide remote call control (RCC) functions associated with a Private Branch Exchange (PBX) telephone via a software application that does not access a third-party interface between the PBX telephone and the software application. In some embodiments, the software application utilizes access to an existing interface associated with a remote same-party application to establish an audio call between the PBX telephone and a destination telephone.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 is an illustration of an example implementation in accordance with one or more embodiments.

FIG. 3 is a bounce diagram in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 illustrates various components of an example device that can be implemented as any type of computing device as described herein.

FIG. 7 illustrates various components of an example device that can be implemented as any type of computing device as described herein.

### DETAILED DESCRIPTION

Overview

Various embodiments provide remote call control (RCC) functions associated with a PBX telephone via a software application that does not access a third-party interface between the PBX telephone and the software application. For example, a desktop computer application can remotely initiate an audio call using the PBX telephone as the initiating caller, and without the desktop computer application interfacing with a CSTA gateway. Alternately or additionally, the software application can control various features associated with the PBX telephone, such as call forwarding, voicemail access, teleconferencing with multiple participants, and so forth, by interfacing with a same-party application and/or interface instead of a third-party interface. In some embodiments, the software application utilizes the same-party application and/or interface to establish the audio call between the PBX telephone and a destination telephone.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

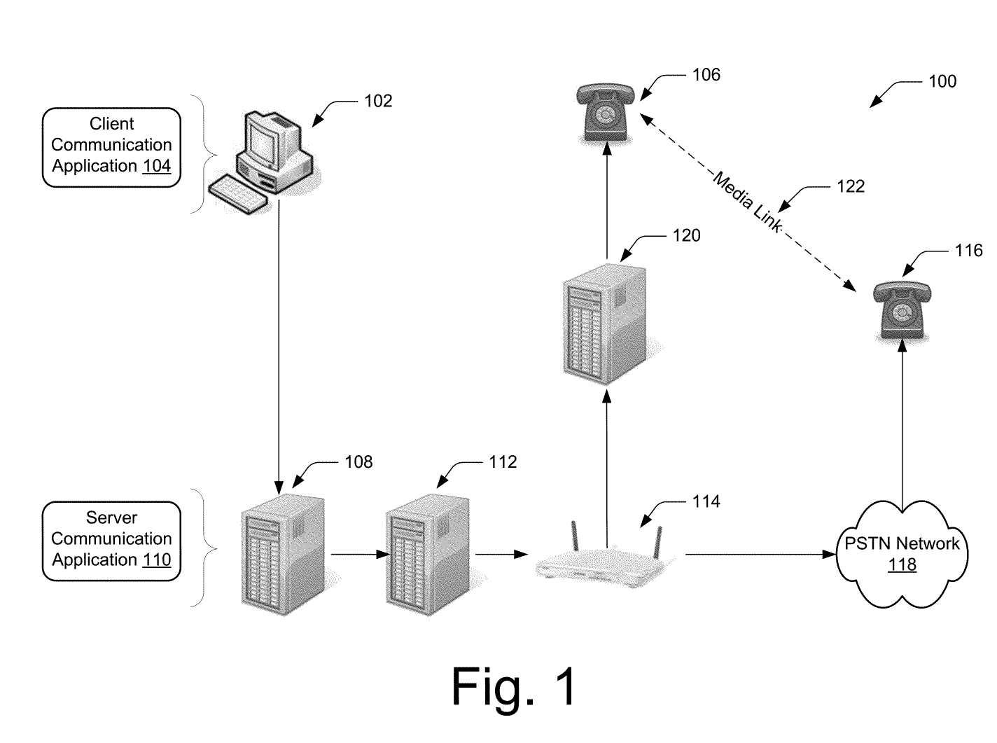

FIG. 1 illustrates an operating environment in accordance with one or more embodiments, generally indicated here as environment 100. Environment 100 includes computing device 102 in the form of a desktop personal computer. However, it is to be appreciated that this is merely for illustrative purposes, and that computing device 102 can be any suitable type of computing device such as, by way of example and not of limitation, a hand held tablet, a laptop, a mobile device, and so forth. Among other things, computing device 102 includes client communication application 104.

Client communication application 104 represents functionality that enables computing device 102 to simulate remote call control (RCC) of an audio call using telephone 106. In some embodiments, client communication application 104 is configured as a client application associated with enterprise software. Enterprise software can include, by way of example and not limitation, a collection of programs with common business applications, tools for modeling how the entire organization works, and development tools for building applications unique to the organization. In this example, telephone 106 is a physical telephone device that is connected to a Private Branch Exchange (PBX). Among other things, client communication application 104 provides a user of computing device 102 with the ability to place an outgoing audio call and/or receive incoming calls on telephone 106 remotely (i.e. from the application instead of manual hardware buttons on telephone 106). In some embodiments, client communication application 104 includes multiple communication modalities, such as a modality associated with audio calls, a modality associated with instant messaging application, a modality associated with video messaging and/or video conferencing, a modality associated with application sharing, a modality associated with web conferencing, and so forth. Alternately or additionally, client communication application 104 provides at least some of these various modalities without the intervention of a third-party interface between computing device 102 and telephone 106, as further described above and below. For instance, client communication application 104 can interface with a remote same-party application, such as compliment enterprise application on server 108, to control audio communications. In some embodiments, client communication application 104 communicates with server 108 and/or server communication application using HyperText Transfer Protocol (HTTP) messaging.

Server 108 provides infrastructure and/or system support for real-time communication exchanges, such as those associated with an instant message application, audio calls, etc. Server 108 includes server communication application 110, which realizes at least part of the infrastructure and/or system support in the form of a software application. However, server communication application 110 can be implemented in any suitable combination of hardware, software, and/or firmware without departing from the scope of the claimed subject matter. At times, server communication application 110 includes enterprise software associated with a same organization as client communication application 104. Here, server communication application 110 supports and/or provides services, such as structured audio/video/web conferencing, VoIP, presence information, connectivity into other networks, and so forth. When client communication application 104 wishes to initiate an audio call using telephone 106, it communicates with server communication application 110 to access the associated services and/or functionality. In turn, server 108 signals related events to mediation server 112 and/or gateway 114.

Among other things, mediation server 112 receives signals, media streams, etc. from server 108, and translates these signals, media streams, etc. into compatible format(s) for gateway 114 and/or external networks. Alternately or additionally, mediation server 112 receives media streams from gateway 114 and translates them into compatible format(s) for server 108. While mediation server 112 is illustrated as separate server hardware than server 108, it is to be appreciated and understood that this is merely for illustrative purposes, and that mediation server 112 can alternately be implemented on server 108 in hardware, software, and/or firmware without departing from the scope of the claimed subject matter. In some embodiments, mediation server 112 can exchange Session Initiated Protocol (SIP) messages with server 108, server communication application 110, and/or gateway 114.

Gateway 114 represents functionality that converts digital media streams between disparate networks, such as translations between an Internet-Protocol (IP) based network and a telecommunications network (i.e Public Switched Telephone Network (PSTN), PBX, Signaling System No. 7 (SS7), Next Generation Network wireless networks (2nd Generation (2G) for Global System for Mobile Communications (GSM), 3^{rd} Generation (3G), General Packet Radio Service (GPRS), etc.). Among other things, gateway 114 converts data between the different transmission and coding techniques of the associated networks it bridges. This can include conversions between Time-Division Multiplexing (TDM) to a media streaming protocol, as well as signaling protocols utilized for VoIP. For example, when client communication application 104 initiates an audio call, gateway 114 determines which network the audio call is directed through. Here, the destination callee of the audio call is represented by telephone 116. Gateway 114 determines that telephone 116 is connected through PSTN 118, and performs signaling, messaging, and/or protocol conversions between the PSTN and mediation server 112 (such as SIP messaging). Similarly, gateway 114 determines that telephone 106 is connected through PBX server 120, and performs the necessary signaling, messaging, and/or protocol conversions between the PBX network and mediation server 112. While the destination callee (e.g. telephone 116) is illustrated as having a PSTN connection, it is to be appreciated and understood that the destination callee could alternately have connections to other networks, such as the PBX network. Thus, various embodiments enable RCC of audio call connections between telephones within a same calling network (e.g. PBX network), as well as audio call connections between different networks (e.g. PBX and PSTN). When the audio call between telephone 106 and telephone 116 is established, it is conducted over media link 122. At times, server communication application 110 mediates and/or manages this media link.

Having described an example operating environments in which RCC can be utilized using same-party interfaces, consider now a more detailed discussion in accordance with one or more embodiments.

Client Application Control of a PBX phone

VoIP solutions provide a user a way to conduct audio calls between devices through the use of transferring digitally captured audio. When a VoIP solution remains in a same network type (such as two desktop computers engaged in a VoIP call), the data transfer process can remain relatively simple in the aspect that each side of the conversation uses the same signaling, protocols, and/or messaging. However, more complex solutions, such as those employed by PBX systems, can add complexity in translating the audio signal and signaling protocols between the respective networks. For instance, telephone connections external to the PBX phone system have the added complexity of translating the digital audio and/or associated signaling protocols into a format native to the receiving network and/or the receiving device.

One advantage of PBX telephone systems is the ability to remotely control features and/or operations of a PBX telephone from a desktop application. For example, an audio control application running on a computer can be linked to operating functionality of the PBX telephone, such as making an outgoing call, answering an incoming call, transferring a call, forwarding an incoming call, call waiting, and so forth. However, since these systems reside in different network types, making the connection between an audio control application and the PBX telephone involves some translations between the systems. One way a system can achieve this is to employ an extra interface between the audio control application and the PBX phone system to perform these conversions, such as a CSTA gateway. This extra interface allows the audio control application to remotely control the PBX telephone, but in order to do so, the audio control application incorporates additional information on how to interface with the CSTA gateway. When the CSTA gateway is provided by a third-party vendor than the same vendor as the audio control application, this can add an unwanted, and sometimes expensive, coupling into the audio control application.

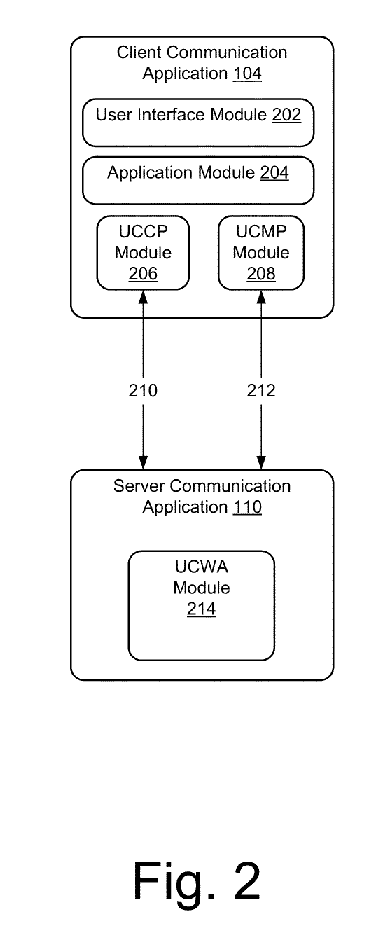

Various embodiments provide RCC functions associated with a PBX telephone via a software application that does not access a third-party interface between the PBX telephone and the software application. To further illustrate, consider FIG. 2, which includes a detailed example of client communication application 104 and server communication application 110 of FIG. 1. For simplicity's sake, these modules are referred to as applications. However, it is to be appreciated and understood that the associated functionality described can be implemented in any suitable combination of hardware, software, and/or firmware without departing from the scope of the claimed subject matter.

Client communication application 104 includes user interface module 202. User interface module 202 provides an input mechanism with which a user can interact and/or exchange data with client communication application 104. In some embodiments, user interface module 202 displays an interface on a display device connected to a computer running client communication application 104. For example, user interface module 202 can display navigable windows that include control buttons, selectable menus, selectable tabs, status information, contact information, and so forth, where activation of the control buttons, menus, etc., interacts with client communication application 104. Alternately or additionally, user interface module 202 exposes a script and/or command line interface with which a user can send and receive commands, data, information, and so forth. Thus, user interface module 202 provides an interaction mechanism into client communication application 104.

Application module 204 represents the logic incorporated in client communication application 104 that provides application functionality, such as VoIP, instant messaging, audio conferencing, etc. To further illustrate, consider the example where client communication application 104 is configured with RCC functionality associated with telephone 106 of FIG. 1. To facilitate RCC of telephone 106, application module 204 could include, by way of example and not of limitation, logic to decide on whether a call is established, whether a call is terminated, how to terminate the call, whether there are multiple calls and how to manage the multiple calls, what communication path to utilize for the call, how to access and utilize contact information, how to retrieve it from an associated server, and so forth. Alternately or additionally, application module 204 includes logic associated with various modalities associated with real-time communications.

Included in client communication application 104 is Unified Communications Client Platform (UCCP) module 206 and Unified Communications Mobile Platform (UCMP) module 208. Here, UCCP module 206 and UCMP module 208 implement different communication protocols used to communicate with server communication module 110. For example, in some embodiments, UCCP module 206 implements a SIP stack. The exchange of information using UCCP module 206 and its associated communication protocol, such as SIP signaling and/or messaging, is illustrated here as communication path 210.

UCMP module 208 additionally implements communication stack, but one that is different from that implemented by UCCP module 206. This provides client communication application 104 with an ability to communicate in multiple ways. In some embodiments, UCMP module 208 implements a HTTP communication stack that is used to send and receive HTTP messages. In turn, client communication application 104 can use the HTTP messages to invoke web Application Program Interfaces (APIs) provided by server communication application 110. The exchange of information using UCMP module 208 and its associated communication protocols, such as HTTP messaging, is represented here as communication path 212. For description purposes, communication path 210 and communication path 212 are shown as separate communication paths to emphasize the different protocols and/or messaging associated with each communication path. However, it is to be appreciated that, while these different communication paths may be associated with different communication protocols, the data associated with each communication protocol can be transmitted over a same transport network, such as the Internet. In this example, the communication paths connect to server communication application 110.

In some embodiments, server communication application 110 includes Unified Communications Web APIs (UCWA) module 214. Among other things, UCWA module 214 provides functionality associated with real-time communications that are accessible through various APIs. This can include, by way of example and not limitation, maintaining presence information associated with multiple client applications, instant messaging services across multiple client applications, searching for contact information, audio calls across multiple client applications, subscription to contact information, scheduling meetings between participants, call functionality (e.g. voice mail, forwarding, redirection, etc.), phone audio, anonymous access, and so forth. To provide RCC, some embodiments of client communication application 104 access these APIs using UCMP module 208.

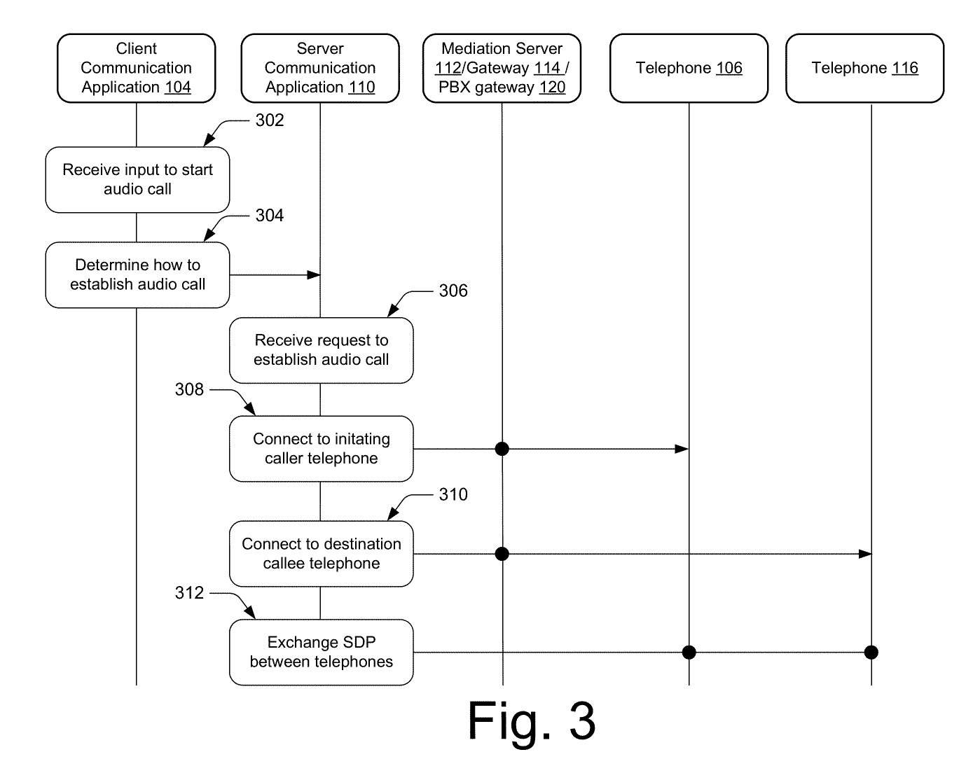

To further illustrate, consider FIG. 3. FIG. 3 is a bounce diagram of interactions between various components that can be used to establish an audio call in accordance with one or more embodiments. Included in FIG. 3 are client communication application 104, server communication application 110, telephone 106, and telephone 116 of FIG. 1. For simplicity's sake, mediation server 112, gateway 114, and PBX server 120 of FIG. 1 have been consolidated to a single illustrative representation, but it is to be appreciated that this consolidation is merely for illustrative purposes, and in no way implies that all three components are used in the associated interaction. For example, some embodiments may not involve mediation server 112 to establish an audio call, while other embodiments may use all three components, varying combinations of two of the components, and so forth. Thus, while these three components are illustrated as a single representation, any suitable combination of the three can be utilized without departing from the scope of the claimed subject matter.

At step 302, client communication application 104 receives input to start an audio call. This can be done in any suitable manner. As described above, client communication application 104 can sometimes display an interactive user interface with RCC features associated with telephone 106. In some embodiments, a user navigates the interactive user interface to locate contact information of potential callees, and then subsequently selects a contact to call. At times, the simple selection of a contact can begin the automated process of client communication application 104 establishing an audio call. Other embodiments involve additional user interaction (i.e. extra selections or navigations). Further, client communication application 104 can be preconfigured (prior to establishing an audio call) to have an association with telephone 106 where contact information associated with telephone 106 is the default contact information. In some cases, when a user selects a contact to initiate an audio call with, the default contact information can then be used to identify telephone 106 in lieu of the user manually selecting it. Here, contact information includes any suitable information that can be used to establish a connection with an associated user and/or contact, such as a telephone number. While a user can select a contact through the displayed user interface, it is to be appreciated that the associated contact information can be acquired in any suitable manner, such as from local storage or remote storage, without departing from the scope of the claimed subject matter.

Responsive to receiving input to establish an audio call, step 304 determines how to establish the audio call. In some embodiments, the received input is passed to application module 204 of FIG. 2 which, as described above, contains logic on how to establish the audio call, and what actions need to be performed. For example, application module 204 can determine whether a current call associated with telephone 106 is in process, and return an error message for display on the user interface if there is a current call in process at the time of the request. Alternately or additionally, application module 204 can determine that no call associated with telephone 106 is currently in process, and contact server communication application 110 and/or UCWA module 214 via UCMP module 208 of FIG. 2 as additionally described above. In some embodiments, application module 204 collects the contact information that is used for the audio call (such as initiating caller contact information and destination callee contact information), and forwards this information to server communication application 110. This can be achieved in any suitable manner, such as through the use of UCMP module accessing APIs associated with UCWA module 214.

At step 306, server communication application 110 receives the request to establish an audio call. For simplicity's sake, this is illustrated as a single directional communications from client communication application 104 to server communication application 110. However, it is to be appreciated and understood that the receiving process can entail a plurality of messages and/or handshakes back and forth between the two applications without departing from the scope of the claimed subject matter. Further, the term “request” is used to denote interaction(s) between the applications and/or an exchange of data. Thus, a call into an API could be considered a “request” in that it entails interaction(s) and/or an exchange of data between applications. In some embodiments, the request is associated with accessing or invoking a back-to-back user agent provided by UCWA module 214. Among other things, a back-to-back user agent operates between the endpoints of an audio call (e.g the initiating caller and the destination callee) to mediate the SIP signaling between the endpoints to establish and maintain audio calls.

Step 308 connects to the initiating caller telephone. For example, the back-to-back user agent can use received contact information to establish a connection to telephone 106. Sometimes this entails the back-to-back user agent managing the SIP messaging used to make the connections. In FIG. 3, this connection process is illustrated generally as going through mediation server 112, gateway 114 and PBX gateway 120, but as discussed above, any combination of these entities could be included or excluded without departing from the scope of the claimed subject matter. In some embodiments, the back-to-back user agent provided by UCWA module 214 manages SIP exchanges between mediation server 112 to establish the connection. Upon receiving these messages, mediation server 112 exchanges SIP messaging with gateway 114, which, in turn, manages exchanges with PBX gateway 120 to establish a connection with telephone 106. From a user experience perspective, this causes telephone 106 to ring. At this point, if a user answered telephone 106, they would hear silence or the process of connecting to the destination callee (e.g. hear the other end ringing).

Similar to step 308, step 310 connects to the destination callee telephone (e.g. telephone 116). As in the case described above, the back-to-back user agent manages SIP messaging used to connect to the destination callee telephone. FIG. 1 illustrates telephone 116 as being connected through a PSTN connection. For this case, the back-to-back user agent manages SIP messaging with mediation server 112, which, in turn, exchanges SIP messaging with gateway 114. At this point, however, gateway 114 redirects the connection process through PSTN 118 of FIG. 1, and performs conversions to the associated signaling protocols. Subsequently, as part of the connection process, a user of telephone 116 would hear the telephone ring. Upon a user answering telephone 116, the back-to-back agent is notified, and exchanges Session Description Protocol (SDP) messaging between the two telephones at step 312 to solidify the connection through a chosen media. While this example describes the connection process between a PBX based telephone and a PSTN based telephone, it is to be appreciated that these techniques can be utilized to connect various types of phones based in different networks, such as PBX telephone to PBX telephone, and so forth.

Thus, the various embodiments described above and below provide the ability for a desktop application to have remote call control of a PBX telephone using an interface into a same-party application, and without a third-party interface/connection (such as a CSTA gateway). When the desktop application and a server application (such as client communication application 104 and server communication application 110) are coupled with one another through shared software provided by a same business, it simplifies how the two applications communicate with one another. When the applications are communicating with applications and/or entities not provided by that same business (e.g. a third-party), the interfacing becomes more complex and more expensive to implement. Using an existing server connection with a same-party application further simplifies the overall system by eliminating an extra entity (e.g. a CSTA gateway) and the additional connections and protocols associated with the extra entity.

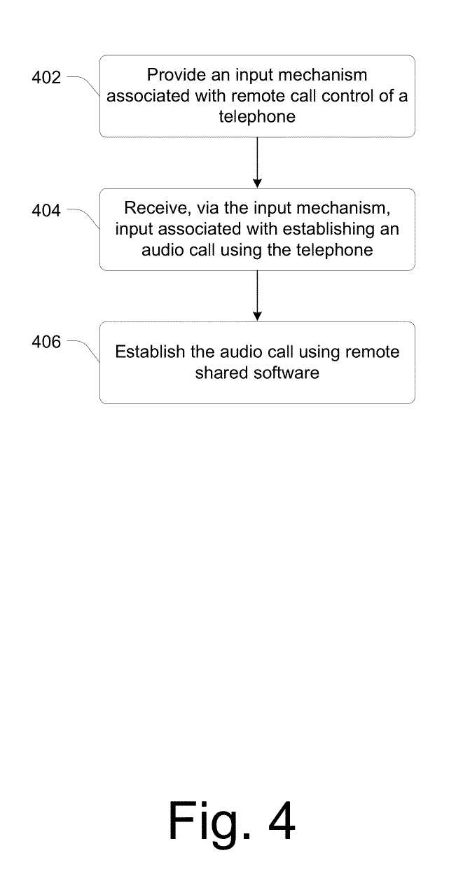

FIG. 4 is a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as client communication application 104 (FIG. 1).

Step 402 provides an input mechanism associated with remote call control of a telephone. Any suitable type of input mechanism can be employed. In some cases, the input mechanism is a navigable user interface associated with a software application. Alternately or additionally, the software application can be a desktop application associated with enterprise software. The remote call control can be any suitable type of control, examples of which are provided above. In some embodiments, the telephone is a PBX telephone.

Step 404 receives, via the input mechanism, input associated with establishing an audio call using the telephone. This can be achieved in any suitable manner, such as through the selection of one or more contacts.

Responsive to receiving the input, step 406 establishes the audio call using remote shared software. Some embodiments establish the audio call without using a third-party interface, as further described above. In some cases, a same-party interface is used, where the remote shared software is server enterprise software, and the software application associated with the input mechanism is a same-party client enterprise application. It is to be appreciated that any suitable type of audio call can be established, such as a PBX-to-PBX based audio call, a PBX-to PSTN based audio call, and so forth.

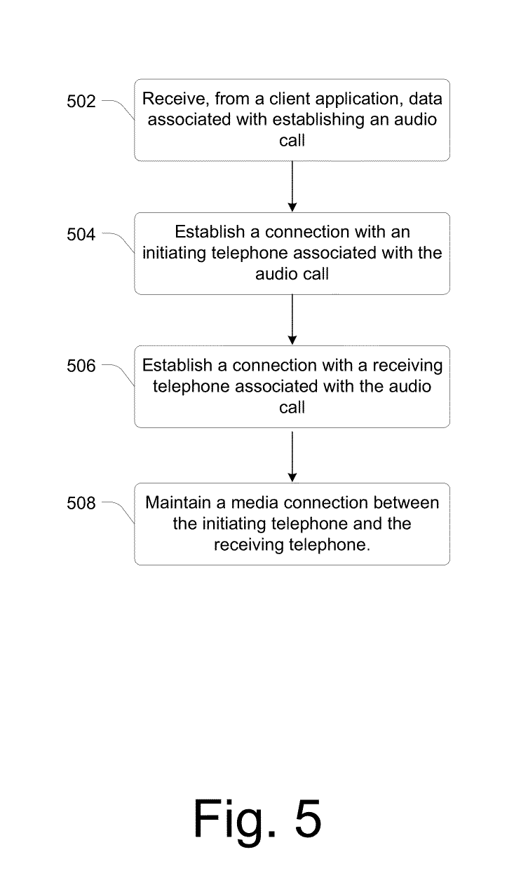

Now consider FIG. 5, which is a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as server communication application 110 (FIG. 1).

Step 502 receives, from a client application, data associated with establishing an audio call. In some embodiments, the data is associated with accessing an API, such as an API associated with a back-to-back user agent, as part of establishing the audio call. Alternately or additionally, the data can be received via HTTP messaging. Some embodiments receive the data using a server enterprise application that is from a same-party vendor as the client application, as further described above.

Responsive to receiving the data associated with establishing the audio call, step 504 establishes a connection with the initiating telephone. This can include using SIP messaging as part of the establishing process. In some embodiments, the initiating telephone is a PBX telephone. Responsive to establishing a connection with the initiating telephone, step 506 establishes a connection with the destination telephone. This, too, can be achieved using SIP messaging. Some embodiments delay establishing a connection with the destination telephone until a confirmation has been received from the initiating telephone that a connection has been established.

Responsive to establishing a connection with the initiating telephone and the destination telephone, step 508 maintains a media connection between the initiating telephone and the destination telephone. Any suitable type of media connection can be maintained, examples of which are provided above.

Having considered an overview on remote call control of a telephone from a software application, consider now a discussion of implementation examples that employ the techniques described above.

Example System and Device

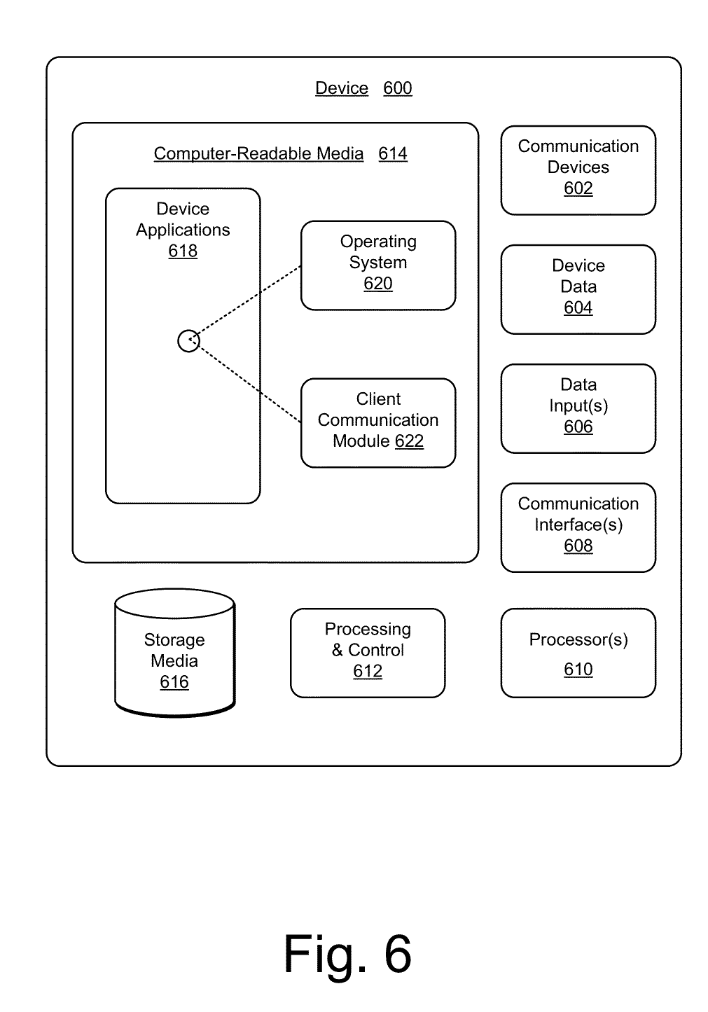

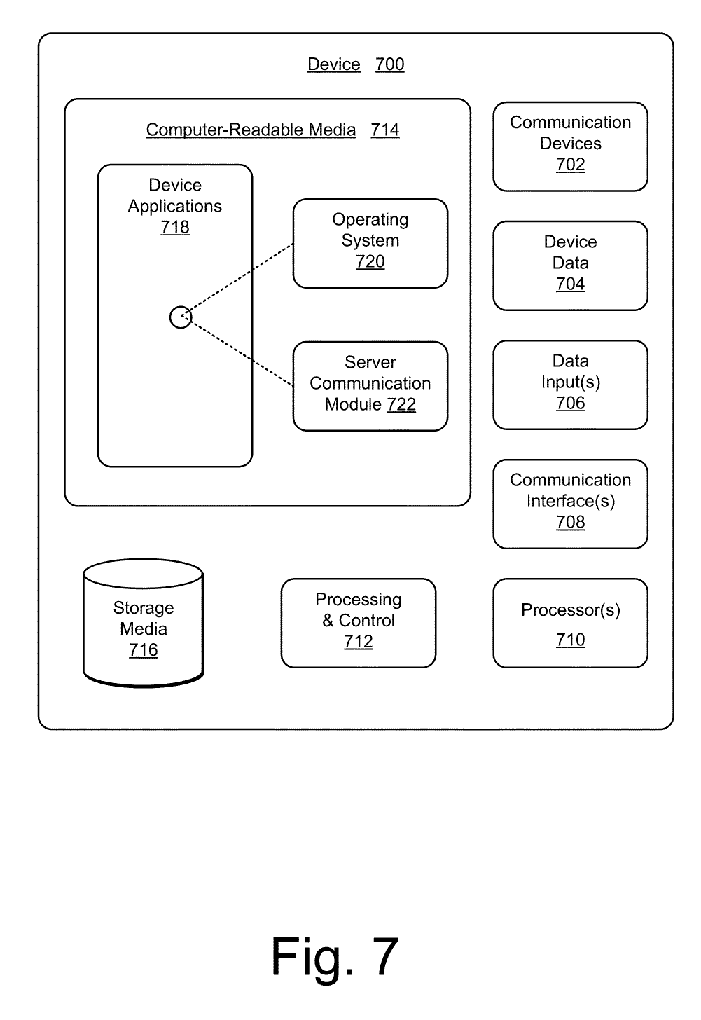

FIGS. 6 and 7 illustrates various components of example devices 600 and 700 that can be implemented as any type of computing device as described with reference to FIGS. 1-3 to implement embodiments of the techniques described herein. Device 600 is illustrative of an example client device, such as client computing device 102 of FIG. 1, while device 700 is illustrative of a server device, such as server 108 of FIG. 1. For the sake of brevity, these devices will be described together where applicable. Components designated as 6XX are associated with device 600, while components designated as 7XX are associated with device 700.

Device 600/700 includes communication devices 602/702 that enable wired and/or wireless communication of device data 604/704 (e.g., received data, data that is being received, data scheduled for broadcast, data packets of the data, etc.). The device data 604/704 or other device content can include configuration settings of the device, media content stored on the device, and/or information associated with a user of the device. Media content stored on device 600/700 can include any type of audio, video, and/or image data. Device 600/700 includes one or more data inputs 606/706 via which any type of data, media content, and/or inputs can be received, such as user-selectable inputs, messages, music, television media content, recorded video content, and any other type of audio, video, and/or image data received from any content and/or data source.

Device 600/700 also includes communication interfaces 608/708 that can be implemented as any one or more of a serial and/or parallel interface, a wireless interface, any type of network interface, a modem, and as any other type of communication interface. The communication interfaces 608/708 provide a connection and/or communication links between device 600/700 and a communication network by which other electronic, computing, and communication devices communicate data with device 600/700.

Device 600/700 includes one or more processors 610/710 (e.g., any of microprocessors, controllers, and the like) which process various computer-executable instructions to control the operation of device 600/700 and to implement embodiments of the techniques described herein. Alternatively or in addition, device 600/700 can be implemented with any one or combination of hardware, firmware, or fixed logic circuitry that is implemented in connection with processing and control circuits which are generally identified at 612/712. Although not shown, device 600/700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600/700 also includes computer-readable media 614/714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600/700 can also include a mass storage media device 616/716.

Computer-readable media 614/714 provides data storage mechanisms to store the device data 604/704, as well as various device applications 618/718 and any other types of information and/or data related to operational aspects of device 600/700. For example, an operating system 620/720 can be maintained as a computer application with the computer-readable media 614/714 and executed on processors 610/710. The device applications 618/718 can include a device manager (e.g., a control application, software application, signal processing and control module, code that is native to a particular device, a hardware abstraction layer for a particular device, etc.). The device applications 618/718 also include any system components or modules to implement embodiments of the techniques described herein.

Device applications 618 include client communication module 622, while device applications 718 include server communication module 722. These modules are shown as software modules and/or computer applications. Client communication module 622 is representative of software that provides an interface effective to enable remote call control of an associated telephone. In some embodiments, client communication module 622 is configured to establish audio calls via a telephone without the use of a third-party interface, as further described above. Server communication module 722 is representative of software that is coupled to client communication module 622 in that they are based off of shared software from a same business. Thus, server communication module 722 represents a software module that is not considered a third-party interface. Alternatively or in addition, client communication module 622 and server communication module 722 can be implemented as hardware, software, firmware, or any combination thereof.

### CONCLUSION

Various embodiments provide remote call control (RCC) functions associated with a PBX telephone via a software application that does not access a third-party interface between the PBX telephone and the software application. For example, a desktop computer application can remotely initiate an audio call using the PBX telephone as the initiating caller, and without the desktop computer application interfacing with a CSTA gateway. Alternately or additionally, the software application can control various features associated with the PBX telephone, such as call forwarding, voicemail access, teleconferencing with multiple participants, and so forth, by interfacing with a same-party application and/or interface instead of a third-party interface. In some embodiments, the software application utilizes the same-party application and/or interface to establish the audio call between the PBX telephone and a destination telephone.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
displaying, using the computer, a user interface associated with remote call control (RCC) of a Private Branch Exchange (PBX) telephone;
receiving, using the computer, input via the user interface, the input associated with initiating an audio call using the PBX telephone; and
communicating, using the computer, with a same-party server application effective to establish the audio call using the PBX telephone.

2. The computer-implemented method of claim 2, wherein the communicating comprises accessing one or more Application Programming Interfaces (APIs) associated with a back-to-back user agent implemented by the same-party server application.

3. The computer-implemented method of claim 3, wherein accessing the one or more APIs further comprises accessing the one or more APIs at least by using HyperText Transfer Protocol (HTTP) messaging.

4. The computer-implemented method of claim 1, wherein communicating with the same-party server application effective to establish the audio call further comprises communicating without interfacing with a Computer Supported Telecommunications Application (CSTA) gateway.

5. The computer-implemented method of claim 1, wherein communicating with the same-party server application further comprises communicating with enterprise software.

6. The computer-implemented method of claim 1, wherein communicating with the same-party server application further comprises:
sending, using the computer, contact information associated with the PBX telephone to the same-party server application; and
sending, using the computer, contact information associated with a destination telephone to the same-party server application.

7. The computer-implemented method of claim 1, wherein receiving input via the user interface further comprises receiving input associated with selection of a contact.

8. One or more computer-readable storage memory devices embodying processor-executable instructions which, responsive to execution by at least one processor, are configured to implement:
a user interface module configured to display one or more selectable controls associated with Remote Call Control (RCC) of a Private Branch Exchange (PBX) telephone;
an application module comprising processing logic associated with one or more real-time communication modalities, at least one real-time communication modality associated with establishing audio calls via the PBX telephone, at least some of the processing logic associated with enterprise software;
a first communication protocol stack module associated with Session Initiated Protocol (SIP) messaging, at least one real-time communication modality configured to utilize the first communication stack module for data transfer; and
a second communication protocol stack module associated with HyperText Transfer Protocol (HTTP) messaging, the at least one real-time communication modality associated with establishing audio calls configured to utilize the second communication protocol stack effective to establish audio calls via server software associated with the enterprise software.

9. The one or more computer-readable storage memory devices of claim 8, wherein the at least one modality configured to utilize the first communication protocol stack comprises a modality associated with instant messaging.

10. The one or more computer-readable storage memory devices of claim 8, wherein the application module is further configured to:
acquire initiating contact information associated with establishing an audio call via the PBX telephone;
acquire destination contact information associated with establishing the audio call; and
forward the initiating contact information and the destination contact information to the server software.

11. The one or more computer-readable storage memory devices of claim 10, wherein the application module is further configured to acquire the initiating contact information by accessing default configuration data.

12. The one or more computer-readable storage memory devices of claim 8, wherein the application module is further configured to access a back-to-back user agent associated with the server software via the second communication protocol stack.

13. The one or more computer-readable storage memory devices of claim 8, wherein an audio call comprises a Voice-over-Internet Protocol (VoIP) audio call.

14. The one or more computer-readable storage memory devices of claim 8, wherein the one or more selectable controls comprise at least one of:
a selectable control associated with initiating an audio call;
a selectable control associated with call forwarding;
a selectable control associated with voicemail access; or
a selectable control associated with voice conferencing.

15. A system comprising:
at least one processor; and
one or more computer-readable storage memories comprising processor executable instructions which, responsive to execution by the at least one processor, are configured to:
provide an input mechanism associated with Remote Call Control (RCC) of a Private Branch Exchange (PBX) telephone;
receive input via the input mechanism, the input associated with initiating an audio call using the PBX telephone; and
communicate with a same-party server application effective to establish the audio call using the PBX telephone and without interfacing with a third-party interface.

16. The system of claim 15, wherein the third-party interface comprises a Computer Supported Telecommunications Application (CSTA) gateway.

17. The system of claim 15, wherein the processor-executable instructions to communicate with a same-party server application are further configured to communicate with the same-party server application using HyperText Transfer Protocol (HTTP) message.

18. The system of claim 17, wherein the processor-executable instructions to communicate with a same-party server application are further configured to access a back-to-back user agent.

19. The system of claim 15, wherein the processor-executable instructions are further configured to:
acquire initiating contact information associated with establishing the audio call;
acquire destination contact information associated with establishing the audio call; and
forward the initiating contact information and the destination contact information to the same-party server application.

20. The system of claim 19, wherein the destination contact information is associated with a Public Switched Telephone Network (PSTN).
